(19) United States
(12) Patent Application Publication
(10) Pub. No.: US 2016/0006617 A1
(43) Pub. Date: Jan. 7, 2016

(54) CLOUD APPLICATION BANDWIDTH MODELING

(71) Applicant: HEWLETT-PACKARD DEVELOPMENT COMPANY, L.P., Houston, TX (US)

(72) Inventors: Jung Gun Lee, Palo Alto, CA (US); Lucian Popa, Palo Alto, CA (US); Yoshio Turner, Palo Alto, CA (US); Sujata Banerjee, Palo Alto, CA (US); Puneet Sharma, Palo Alto, CA (US)

(21) Appl. No.: 14/773,238

(22) PCT Filed: Mar. 7, 2013
(86) PCT No.: PCT/US13/29683

§ 371 Date: Sep. 4, 2015

(51) Int. Cl. H04L 12/24; G06F 9/455

(52) U.S. Cl. CPC H04L 41/145; H04L 41/0896; G06F 9/45533

(57) ABSTRACT

According to an example, a cloud bandwidth modeling system may determine components for an application, create a vertex for each component in a graph representing a bandwidth model for the application, determine bandwidth requirements between each component, and create directed edges between the components to represent the bandwidth requirements.

### BACKGROUND

Cloud computing services have grown immensely in popularity. Users may be provided with access to software applications and data storage as needed on the cloud without having to worry about the infrastructure and platforms that run their applications and store their data. In some cases, tenants may negotiate with the cloud service provider to guarantee certain performance of their applications so they can operate with the desired level of service.

### BRIEF DESCRIPTION OF DRAWINGS

The embodiments are described in detail in the following description with reference to examples shown in the following figures.

FIG. 1 illustrates an example of a cloud computing system.

FIG. 2 illustrates an example of a Tenant Application Graph (TAG).

FIG. 3 illustrates a more detailed illustration of the TAG from FIG. 2 according to an example.

FIG. 4 illustrates an example of a method for creating a TAG.

FIG. 5 illustrates an example of a method for placement of VMs for components in a TAG.

FIG. 6 illustrates a computer system that may be used for the methods and systems.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments and examples may be practiced without limitation to all the specific details and the embodiments and examples may be used together in various combinations.

A cloud bandwidth modeling and deployment system according to an example can generate a model to describe bandwidth requirements for software applications running in the cloud. The model may include a Tenant Application Graph (TAG), and tenants can use a TAG to describe bandwidth requirements for their applications. The TAG, for example, provides a way to describe the bandwidth requirements of an application, and the described bandwidths may be reserved on physical links in a network to guarantee those bandwidths for the application. The TAG for example models the actual communication patterns of an application, such as between components of an application, rather than modeling the topology of the underlying physical network which would have the same model for all the applications running on the network. The modeled communication patterns may represent historic bandwidth consumption of application components. The TAG may leverage the tenant's knowledge of an application's structure to provide a concise yet flexible representation of the bandwidth requirements of the application. The cloud bandwidth modeling and deployment system may also determine a placement of virtual machines (VMs) on physical servers in the cloud based on a TAG. An application for a component can request bandwidth, and the cloud bandwidth modeling and deployment system uses the bandwidth requirements in the TAG to reserve bandwidth. Bandwidth can be reserved on physical links in the cloud for the VMs of the component to enforce bandwidth guarantees.

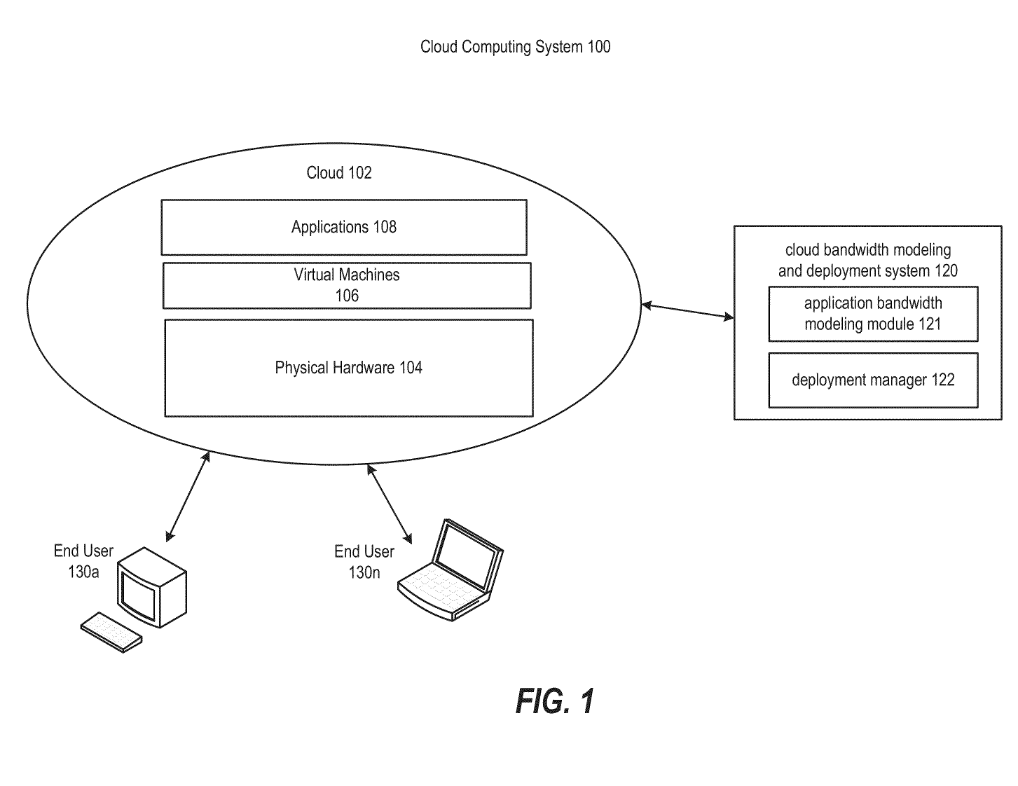

FIG. 1 illustrates an example of a cloud computing system 100 including a cloud bandwidth modeling and deployment system 120 and a cloud 102. The cloud 102 may include physical hardware 104, virtual machines 106, and applications 108. The physical hardware 104 may include, among others, processors, memory and other storage devices, servers, and networking equipment including switches and routers. The physical hardware performs the actual computing and networking and data storage.

The virtual machines 106 are software running on the physical hardware 104 but designed to emulate a specific set of hardware. The applications 108 are software applications executed for the end users 130a-n and may include enterprise applications or any type of applications. The cloud 102 may receive service requests from computers used by the end users 130a-n and perform the desired processes for example by the applications 108 and return results to the computers and other devices of the end users 130a-n for example via a network such as the Internet.

The cloud bandwidth modeling and deployment system 120 includes application bandwidth modeling module 121 and deployment manager 122. The application bandwidth modeling module 121 generates TAGs to model bandwidth requirements for the applications 108. Bandwidth requirements may include estimates of bandwidth needed for an application running in the cloud 102 to provide a desired level of performance. The deployment manager 122 determines placement of one or more of the VMs 106 on the physical hardware 104. The VMs 106 may be hosted on servers that are located on different subtrees in a physical network topology that has the shape of a tree. The deployment manager 122 can select placement in various subtrees to optimize for required network bandwidth guarantees, for example by minimizing the bandwidth guarantees for links that traverse the core switch in a tree-shaped physical network. The cloud bandwidth modeling and deployment system 120 may comprise hardware and/or machine readable instructions executed by the hardware.

TAGs which may be generated by the application bandwidth modeling module 121 are now described. A TAG may be represented as a graph including vertices representing application components. An application component for example is a function performed by an application. In one example a component is a tier, such as a database tier handling storage, a webserver tier handling requests or a business logic tier executing a business application function. The size and bandwidth demands of components may vary over time. A component may include multiple instances of the code executing the function or functions of an application. The multiple instances may be hosted by multiple VMs. A component may alternatively include a single instance of code performing the function of the component and running on a single VM. Each instance may have the same code base and multiple instances and VMs may be used based on demand. By way of example, a component may include multiple webserver instances in a webserver tier to accommodate requests from the end users 130a-n.

Since many applications are conceptually composed of multiple components, a tenant can provide to the cloud bandwidth modeling and deployment system 120 the components in an application. The tenant may be a user that has an application hosted on the cloud 102. In one example, the tenant pays a cloud service provider to host the application and the cloud service provider guarantees performance of the application, which may include bandwidth guarantees. The application bandwidth modeling module 121 can map each component to a vertex in the TAG. The user can request bandwidth guarantees between components. The application bandwidth modeling module 121 can model requested bandwidth guarantees between components by placing directed edges between the corresponding vertices. Each directed edge e=(u, v) from tier u to tier v is labeled with an ordered pair (Sₑ,Rₑ) that represents per-VM bandwidth guarantees for the traffic, whereby the tiers are components. Specifically, each VM in component u is guaranteed bandwidth Se for sending traffic to VMs in component v, and each VM in component v is guaranteed bandwidth Re to receive traffic from VMs in component u. Two edges in opposite directions between two components can be combined into a single undirected edge when the incoming/outgoing values for each component are the same (i.e., S(u,v)=R(v,u) and R(u,v)=S(v,u)).

Having two bandwidth values for sending and receiving traffic instead of a single value for a requested bandwidth is useful when the size of the two components are different. In this way, the total bandwidth outgoing from one component and incoming to the other component can be equalized such that bandwidth is not wasted. If components u and v have sizes Nᵤ and Nᵥ, respectively, then the total bandwidth guarantee for traffic sent from component u to component v is B_{u→v}=min(Sₑ·Nᵤ, Rₑ·Nᵥ).

To model communication among VMs within a component u, the TAG allows self-loop edges of the form e=(u,u). The self-loop edges are labeled with a single bandwidth guarantee (SRₑ). In this case, SRₑ represents both the sending and the receiving guarantee of one VM in that component (or vertex).

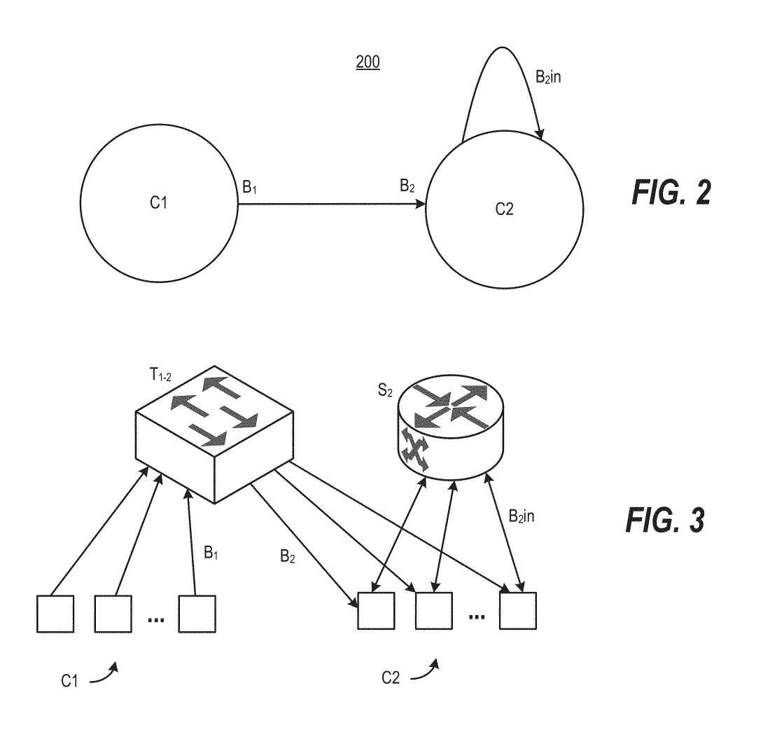

FIG. 2 shows a TAG 200 in a simple example of an application with two components C1 and C2. In this example, a directed edge from C1 to C2 is labeled (B₁,B₂). Thus, each VM in C1 is guaranteed to be able to send at rate B₁ to the set of VMs in C2. Similarly, each VM in C2 is guaranteed to be able to receive at rate B₂ from the set of VMs in C1. To guarantee the bandwidth, the application bandwidth modeling module 121 models the application with a TAG and the deployment manager 122 determines placement of VMs according to the TAG and reserves bandwidth for the VMs on the links according to the bandwidth requirements, such as B₁ and B₂. The TAG 200 has a self-edge for component C2, describing the bandwidth guarantees for traffic where both source and destination are in C2.

FIG. 3 shows an alternative way of visualizing the bandwidth requirements expressed in FIG. 2. To model the bandwidth guarantees between C1 and C2, each VM in C1 is connected to a virtual trunk T_{1→2} by a dedicated directional link of capacity B₁. Similarly, virtual trunk T_{1→2} is connected through a directional link of capacity B₂ to each VM in C2. The virtual trunk T_{1→2} represents directional transmission from C1 to C2 and may be implemented in the physical network by one switch or a network of switches. The TAG example in FIG. 3 has a self-edge for component C2, describing the bandwidth guarantees for traffic where both source and destination are in C2. The self-loop edge in FIG. 3 can be seen as implemented by a virtual switch S2, to which each VM in C2 is connected to a bidirectional link of capacity B₂ⁱⁿ. The virtual switch S2 represents bidirectional connectivity. S2 may be implemented by a network switch.

The TAG is easy to use and moreover, since the bandwidth requirements specified in the TAG can be applied from any VM of one component to the VMs of another component, the TAG accommodates dynamic load balancing between application components and dynamic re-sizing of application components (known as “flexing”). The per-VM bandwidth requirements Se and Re do not need to change while component sizes change by flexing.

The TAG can also accommodate middleboxes between the application components. Many types of middleboxes, such as load balancers and security services, examine only the traffic in one direction, but not the reverse traffic (e.g., only examine queries to database servers but not the replies from servers). The TAG model can accommodate these unidirectional middleboxes as well.

Since queries often consume significantly less bandwidth than responses, the ability to specify directional bandwidths allows a TAG to deploy up to 2× more guarantees than a unidirectional model. For example, a VM with a high outgoing bandwidth requirement can be located on the same server with a VM with a high incoming bandwidth requirement.

Users can identify the per VM guarantees to use in the TAG through measurements or compute them using the processing capacity of the VMs and a workload model.

TAG deployment which may be determined by the deployment manager 122 is now described. Deploying the TAG may include optimizing the placement of VMs on physical servers in the physical hardware 104 while reserving the bandwidth requirements on physical links in a network connecting the VMs 106. Then, bandwidth may be monitored to enforce the reserved bandwidths.

In one example, VMs are deployed in such a manner that as many VMs are deployed as possible on a tree-shaped physical topology while providing the bandwidth requirements which may be specified by a tenant. The deployment may minimize the bandwidth usage in an oversubscribed network core, assumed to be the bottleneck resource for bandwidth in a tree-shaped network topology. The tree may include a root network switch, intermediate core switches (e.g., aggregation switches) and low-level switches below the core switches and connected to servers that are leaves in subtrees (e.g., top of rack switches). The tree and subtrees may include layer 3 and layer 2 switches. In one example, the smallest feasible subtree of the physical topology is selected for placement of VMs for a TAG. In the chosen subtree, the components that heavily talk to each other are placed under the same child node. Components that have bandwidth requirements greater than a predetermined threshold may be considered heavy talkers. The threshold may be determined as a function of all the requested bandwidths. For example, the highest 20% may be considered “heavy talkers” or a threshold bandwidth amount may be determined from historical analysis of bandwidth requirements. A minimum cut function may be used to determine placement of these components. For example, the placement of these components is the problem of finding the minimum capacity cut in a directed network G with n nodes. A minimum cut function may be used to determine the placements. For example, Hao and Orlin disclose a highly-cited minimum-cut function for solving the minimum-cut problem in Hao, Jianxiu; Orlin, James B. (1994). “A faster algorithm for finding the minimum cut in a directed graph”. J. Algorithms 17: 424-446. Other minimum-cut functions may be used.

Components that remain to be placed after the minimum cut phase is completed may try to consume core bandwidth independently of their placement in the subtree. To minimize core bandwidth consumption, the VMs of these remaining components may be placed in a manner that maximizes server consolidation by fully utilizing both link bandwidth and other resources (CPU, memory, etc.) of individual servers. This may be accomplished by solving the problem as a Knapsack problem. Several functions are available to solve the knapsack problem. One example is disclosed by Vincent Poirriez, Nicola Yanev, Rumen Andonov (2009), “A Hybrid Algorithm for the Unbounded Knapsack Problem Discrete Optimization.” In one example, for the components that remain that do not communicate much with each other (e.g., have no directed edge between each other or have a directed edge with a bandwidth less than a threshold) may be placed together if one component has a high bandwidth requirement with other components and the other component has a low bandwidth requirement with other components. Once component placement is determined, bandwidth may be reserved on the physical links for the components for example based on traffic distribution between VMs in a component.

Methods 400 and 500 are described with respect to the cloud bandwidth modeling and deployment system 120 shown in FIG. 1 by way of example. The methods 400 and 500 may be performed in other systems.

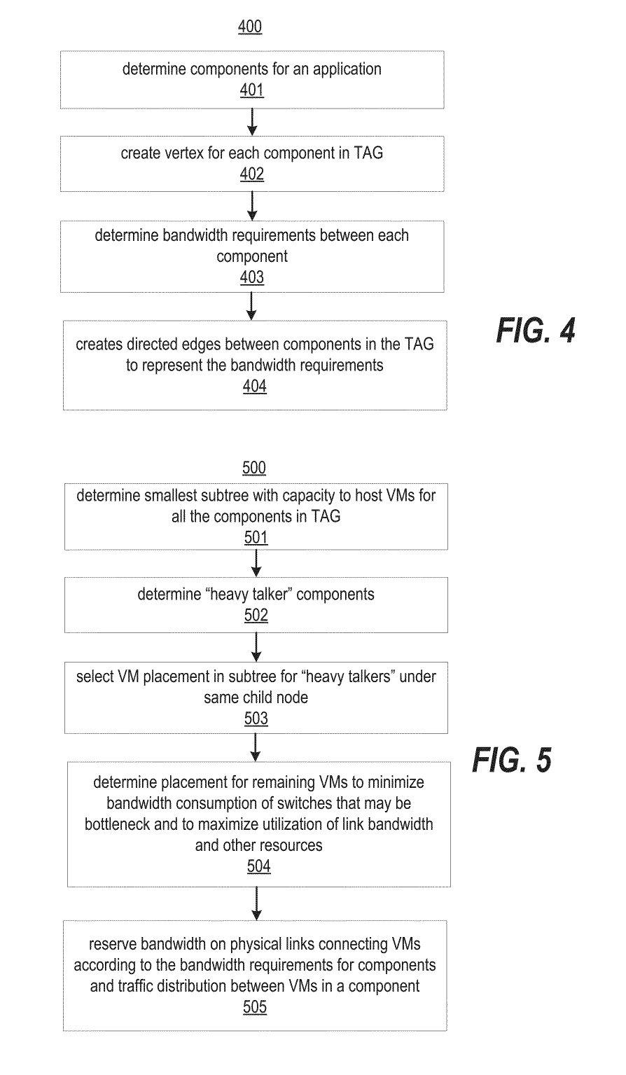

FIG. 4 illustrates the method 400 according to an example for creating a TAG. The TAG for example models bandwidth requirements for an application hosted by VMs in a distributed computing environment based on communication patterns between components of the application. At 401, the application bandwidth modeling module 121 determines components for an application. For example, the cloud bandwidth modeling and deployment system 120 receives an indication of components in an application for example from user input provided by a tenant, and provides the list of components to the application bandwidth modeling module 121. The cloud bandwidth modeling and deployment system 120 may have a graphical user interface for the user to enter the components or the user may provide the list of components in a file to the cloud bandwidth modeling and deployment system 120.

At 402, the application bandwidth modeling module 121 creates a vertex for each component in the TAG. At 403, the application bandwidth modeling module 121 determines bandwidth requirements between each component. The bandwidth requirements may be received from a user, such as a tenant. For example, the tenant can identify the per VM guarantees to use in the TAG through measurements or compute them using the processing capacity of the VMs and a workload model. The bandwidth requirements can be translated into reserved bandwidth/guarantees on different links in the network connecting the VMs. A bandwidth requirement for example is bandwidth for unidirectional transmission from a VM for one component to a VM of another component and may include a send rate, such as B₁ shown in FIG. 3, and a receive rate, such as B₂ shown in FIG. 3. Bandwidth requirements may also be specified for VMs that communicate with each other in one component, such as shown for C2 in FIGS. 2 and 3.

At 404, the application bandwidth modeling module 121 creates directed edges between the components in the TAG to represent the bandwidth requirements.

FIG. 5 illustrates the method 500 for placement of VMs for the components represented in a TAG according to an example. For example, the deployment manager 122 of the cloud bandwidth modeling and deployment system 120 determines placement of the VMs. At 501, the deployment manager 122 determines a smallest subtree of a physical topology of an underlying physical network in the cloud 102 that has the capacity to host VMs for all the components in the TAG. The physical topology of the network may be represented as a tree structure including a root switch, intermediate switches connected to the root switch, and low-level switches connected to the intermediate switches and servers. The tree structure may comprise multiple subtrees including switches and servers.

At 502, the deployment manager 122 determines the components in the TAG that have bandwidth requirements greater than a threshold, which may be a relative threshold or a predetermined bandwidth. These components are considered “heavy talkers”. In one example, a relative threshold is used to determine heavy talkers. For example, the relative threshold is calculated as the available uplink (connecting a node to its parent node) bandwidth divided by the number unused VM slots under the node (switch or server) on which is being considered for deploying the components of interest.

At 503, the deployment manager 122 selects VM placement for these components under the same child node (e.g., the same switch) in the selected subtree. For example, the “heavy talker” components are placed on the same server or on servers that are connected to the same switch in the subtree. A minimum cut function may be used to place these components. For example, the placement of these components is the problem of finding the minimum capacity cut in a directed network G with n nodes. A minimum cut function may be used to determine the placements.

At 504, the deployment manager 122 determines placement for the remaining VMs for example to minimize bandwidth consumption of switches that may be bottleneck and to maximize utilization of link bandwidth and other resources (CPU, memory, etc.) of individual servers. In one example, for the components that remain that do not communicate much with each other (e.g., have no directed edge between each other or have a directed edge with a bandwidth less than a threshold) may be placed together if one component has a high bandwidth requirement with other components and the other component has a low bandwidth requirement with other components. This may be accomplished by solving the problem as a Knapsack problem.

At 505, bandwidth is reserved on the physical links connecting the VMs according to the bandwidth requirements for the components and the traffic distribution between VMs in a component. For example, assume bandwidth is being reserved for traffic between two components u and v on a link L delimiting a subtree denoted T. Assume Nᵤᵢₙ VMs of the of the Nᵤ VMs of component u are placed inside subtree T and Nᵥₒᵤₜ of the Nᵥ VMs of component v are placed outside subtree T. In the typical case, when the traffic distribution from the transmitting component to the receiving component is not known, bandwidth may be reserved for the worst case traffic distribution.

B_{u→v}(link L)=min(Sₑ·Nᵤ_{ᵢₙ},Rₑ·Nᵥ_{ₒᵤₜ}).

This reservation is tailored for the worst case, when all Nᵤᵢₙ VMs send traffic to all Nᵥₒᵤₜ destination VMs.

In case the traffic distribution is known a priori, bandwidth can be reserved in a more efficient way. For example, if the traffic from every transmitting VM is evenly distributed to all destination VMs, (perfect uniform distribution), the bandwidth to reserve on link L becomes:

$${B}_{u \to v} ( link L ) = min ( \frac{{N}_{{v}_{out}}}{{N}_{v}} \cdot {S}_{e} \cdot {N}_{{u}_{in}} , \frac{{N}_{{u}_{in}}}{{N}_{u}} \cdot {R}_{e} \cdot {N}_{v\_out} ) .$$

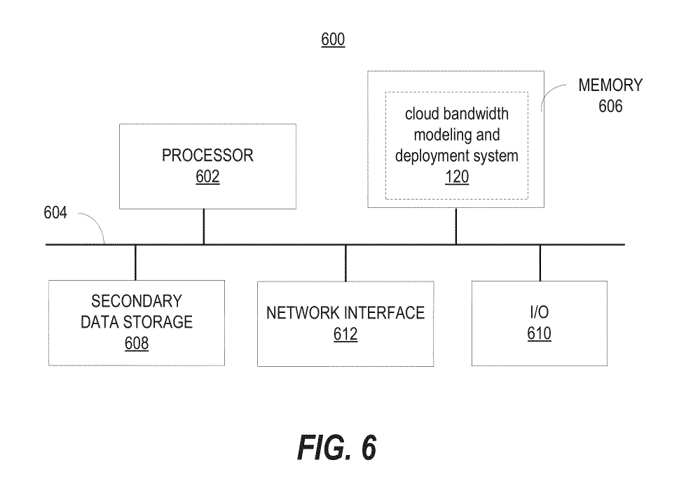

FIG. 6 shows a computer system 600 that may be used with the embodiments and examples described herein. The computer system 600 includes components that may be in a server or another computer system. The computer system 600 may execute, by one or more processors or other hardware processing circuits, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 600 includes at least one processor 602 that may implement or execute machine readable instructions performing some or all of the methods, functions and other processes described herein. Commands and data from the processor 602 are communicated over a communication bus 604. The computer system 600 also includes a main memory 606, such as a random access memory (RAM), where the machine readable instructions and data for the processor 602 may reside during runtime, and a secondary data storage 608, which may be non-volatile and stores machine readable instructions and data. For example, machine readable instructions for the cloud bandwidth modeling and deployment system 120 may reside in the memory 606 during runtime. The memory 606 and secondary data storage 608 are examples of computer readable mediums.

The computer system 600 may include an I/O device 610, such as a keyboard, a mouse, a display, etc. For example, the I/O device 610 includes a display to display drill down views and other information described herein. The computer system 600 may include a network interface 612 for connecting to a network. Other known electronic components may be added or substituted in the computer system 600.

While the embodiments have been described with reference to examples, various modifications to the described embodiments may be made without departing from the scope of the claimed embodiments.

What is claimed is:

1. A cloud bandwidth modeling system comprising:
an application bandwidth module executed by a processor to determine components for an application, create a vertex for each component in a graph representing a bandwidth model for the application, determine bandwidth requirements between each component, and create directed edges to represent the bandwidth requirements, wherein the bandwidth requirements are for bandwidth on links in a network connecting virtual machines (VMs) running the components.

2. The cloud bandwidth modeling system of claim 1, wherein each bandwidth requirement is bandwidth required for unidirectional transmission from a VM for one of the components to a set of VMs in another one of the components or to a set of VMs in the same component and includes a send rate for the VM sending the unidirectional transmission to the set of receiving VMs and a receive rate for a VM receiving the unidirectional transmission from a set of sending VMs.

3. The cloud bandwidth modeling system of claim 1, wherein the model models actual communication patterns of the application.

4. The cloud bandwidth modeling system of claim 1, wherein each component includes machine readable instructions executed on VMs to perform a function of the application, and the VMs for the components are hosted by computer resources in a cloud computing system.

5. The cloud bandwidth modeling system of claim 1, comprising:
a deployment manager executed by the processor to determine placement of VMs for each of the components in a cloud computing system.

6. The cloud bandwidth modeling system of claim 5, wherein the deployment manager is to determine the placement of the VMs by determining a smallest subtree of a physical topology of an underlying physical network in the cloud computing system that has the capacity to host the VMs, wherein the physical topology includes a tree structure including a root switch, intermediate switches connected to the root switch, and low-level switches connected to the intermediate switches and servers hosting the VMs.

7. The cloud bandwidth modeling system of claim 6, wherein the deployment manager is to determine VMs for components in the TAG that have high bandwidth requirements to communicate with each other and to place the VMs for those components under the same child node in the subtree.

8. The cloud bandwidth modeling system of claim 7, wherein the deployment manager is to determine placement for remaining VMs for the components that have not been placed in the previous phase to maximize utilization of both link bandwidth and other resources of the child nodes including switches or servers.

9. The cloud bandwidth modeling system of claim 8, wherein of the remaining VMs, VMs that have high bandwidth requirements and don't communicate with each other are placed in the same server or the same server cluster.

10. The cloud bandwidth modeling system of claim 8, wherein the deployment manager is to reserve the bandwidth requirements on physical links connecting the VMs for the components.

11. The cloud bandwidth modeling system of claim 10, wherein the reserved bandwidths for VMs for a component are based on the traffic distribution from the VMs of the component to VMs of other components.

12. A method for creating a model for bandwidth requirements for an application, the method comprising:
determining components for an application, wherein each component includes multiple VMs, and each VM for the component executes the same function;
determining bandwidth requirements between each component;
creating, by a processor, a model for the application wherein creating the model includes creating a vertex for each component in a graph; and creating directed edges to represent the bandwidth requirements, wherein the bandwidth requirements are for bandwidth on links in a network connecting the VMs of different ones of the components or connecting the VMs of one of the components.

13. The method of claim 12, wherein the bandwidth requirement for one of the components is bandwidth required for unidirectional transmission from the VMs for the component to the VMs of another one of the components, and the bandwidth required includes a send rate for sending the unidirectional transmission and a receive rate for receiving the unidirectional transmission.

14. The method of claim 12, wherein the bandwidth requirements are per-VM and the bandwidth requirements do not change if component sizes change by flexing to a larger or smaller number of VMs based on demand.

15. A non-transitory computer readable medium including machine readable instructions executable by a processor to:
determine components for an application;
create a vertex for each component in a graph representing a bandwidth model for the application;
determine bandwidth requirements between each component; and
create directed edges to represent the bandwidth requirements, wherein the bandwidth requirements are for bandwidth on links in a network connecting VMs running the components.
